(19) United States
(12) Patent Application Publication
(10) Pub. No.: US 2023/0148240 A1
(43) Pub. Date: May 11, 2023

(54) PRODUCTION OF AN OBJECT BY WAY OF TWO-PHOTON POLYMERIZATION

(71) Applicant: Ruhr-Universität Bochum, Bochum (DE)

(72) Inventors: Nils Dominik Surkamp, Bochum (DE); Gordon Zyla, Gelsenkirchen (DE); Martin Hofmann, Hattingen (DE); Cemal Esen, Duisburg (DE); Evgeny Gurevich, Münster (DE)

(21) Appl. No.: 17/924,222

(22) PCT Filed: Jun. 2, 2021
(86) PCT No.: PCT/EP2021/064785

§ 371 Date: Nov. 9, 2022

(30) Foreign Application Priority Data
Jun. 16, 2020 (DE) 10 2020 115 869.6

(51) Int. Cl. B29C 64/209; B29C 64/135; B29C 64/268

(52) U.S. Cl. CPC B29C 64/209; B29C 64/135; B29C 64/268; B33Y 10/00

(57) ABSTRACT

A write head for producing an object by way of two-photon polymerization, comprising:
a monolithic mode-locked laser diode,
a microscope objective that is configured and arranged to focus laser radiation generated by the monolithic mode-locked laser diode.

The invention relates to a write head, an apparatus, a method, and a use for producing an object by way of two-photon polymerization.

The production of objects by way of two-photon polymerization (2PP for short) is known. It allows small objects to be produced additively by irradiating a photosensitive starting material. The objects can comprise structures having dimensions in the range of a few 100 nm [nanometers]. Two-photon polymerization is thus more flexible compared to other lithographic techniques. Two-photon polymerization thus offers outstanding potential for use in a variety of interdisciplinary technical fields, such as the production of photonic crystals, micropumps for microfluidics, microelectromechanical systems (MEMS), or products in the fields of biology, medicine, or microoptics.

In order to produce the object, the starting material is cured by two-photon polymerization locally where the intensity of the laser radiation is sufficiently high. The starting material is irradiated such that the intensity required for two-photon polymerization is only reached locally where the object is to have material. The production can therefore also be understood as 3D printing.

The starting material can be penetrated by the laser radiation. In principle, two-photon polymerization does not occur in the process. It is only when the laser radiation is focused that the required intensity is achieved in a small volumetric region around the focal point. By selecting the focal point, it is therefore possible to cure the starting material away from its surface at a depth that can be set in a targeted manner. Here it suffices to provide a quantity of the starting material at the start of the method. Because the curing can also take place in the interior of the starting material, it is not necessary to provide the starting material in layers.

In two-photon polymerization, almost simultaneous (quasi-simultaneous) absorption of two photons results in polymerization. The absorption of a single photon would not be sufficient here, because the energy of the photons of the laser radiation used is not sufficient to excite the atoms of the starting material into the first excited state. For excitation, two photons must be absorbed within a time of less than approximately one femtosecond (10⁻¹⁵ s), such that the energy of the two photons together enables the excitation. It is also referred to as the quasi-simultaneous absorption of two photons or “two-photon absorption”. This is a nonlinear optical process.

For two-photon polymerization, it can only occur under certain conditions. In particular, a high energy density is required. This corresponds to a high photon density, i.e. a locally high intensity of the laser radiation. Otherwise, the probability of two photons impinging on an atom within a time span of less than one femtosecond would be very low.

Such high photon densities can be achieved with lasers that emit ultrashort light pulses (“ultrashort pulse lasers”). This is because, with pulsed laser radiation, the pulse peak intensity is scaled inversely with the pulse duration. The effectiveness of the 2PP process therefore depends very heavily on the pulse duration of the laser source. In known methods for two-photon polymerization, Ti: sapphire lasers are used. A laser of this kind must be optically pumped by means of a solid-state laser, which in turn is operated by means of diodes. A system having a Ti: sapphire laser is therefore correspondingly large, has a low energy efficiency, and must be cooled by means of water. In this case, it is not possible to direct the laser radiation directly into the starting material on a short path. For this reason, complex optical elements are required in a Ti: sapphire Laser. Known apparatuses for producing an object by way of two-photon polymerization are correspondingly large, heavy, and expensive. For example, apparatuses of this kind can take up several cubic meters of volume, weigh several 100 kg, and cost several hundred thousand euros.

Proceeding from the described prior art, an object of the present invention is to provide an apparatus for producing an object by way of two-photon polymerization that is smaller, lighter, more energy-efficient, and cheaper than known apparatuses. In addition, a corresponding write head, a corresponding method, and a corresponding use are to be presented.

These objects are achieved with the subject-matter of the independent claims. Further advantageous embodiments are specified in the dependent claims. The features presented in the claims and in the description can be combined with one another in any technologically meaningful way.

According to the invention, a write head for producing an object by way of two-photon polymerization is presented. The write head comprises:

a monolithic mode-locked laser diode,

a microscope objective that is configured and arranged to focus laser radiation generated by the monolithic mode-locked laser diode.

The write head can be used in an apparatus for producing an object by way of two-photon polymerization. In this case, the photosensitive starting material is polymerized and thus cured by means of two-photon polymerization. This can take place locally and selectively, such that the object can be obtained from the starting material. The starting material can also be referred to as the sample. The starting material is irradiated such that the intensity required for two-photon polymerization is only reached locally where the object is to have material. Resins, in particular, can be considered for the photosensitive material. The starting material is moved relative to the write head during production of the object. The laser radiation thus reaches the locations in the starting material which are to be polymerized. The depth at which the starting material is polymerized can be influenced by changing the focal point of the laser radiation and/or by moving the starting material toward or away from the write head. The focal point can be adjusted, for example, by moving the starting material relative to the microscope objective. The object is preferably produced by the focused laser radiation being moved over the starting material in a three-dimensional grid pattern. The starting material can thereby be polymerized at any point in three-dimensional space. The object can thus be obtained by traveling over the starting material. This can be referred to as writing, which is why the write head is referred to as such. Irradiation with the laser radiation can also be referred to as exposure. After the object has been obtained, the remaining starting material at the non-irradiated locations can be removed, for example by a solvent.

The starting material can be held, for example, by a holder with which the starting material can be moved relative to the write head, preferably in three dimensions. The holder is part of the apparatus for producing the object by way of two-photon polymerization, but not the write head. Preferably, the holder is intended and configured to position and/or orient the starting material. For this purpose, the holder preferably comprises drive means. The write head is preferably held rigidly in the apparatus. Alternatively or additionally, the write head can be moved.

The object may be an arbitrarily shaped three-dimensional body, in particular a microobject. The object consists of the polymerized starting material. The object preferably has an extent of less than 0.5 mm [millimeters] in each spatial direction.

The object may comprise structures having dimensions in the order of 100 nm [nanometers]. The object is preferably a photonic crystal, a micropump for microfluidics, a microelectromechanical system (MEMS), or a product in the fields of biology, medicine, or microoptics.

The laser radiation required for the two-photon polymerization is generated by the monolithic mode-locked laser diode. The object may comprise structures having dimensions in the order of 100 nm. The monolithic mode-locked laser diode is preferably designed as a monolithic mode-locked short pulse laser diode, in particular as a monolithic mode-locked ultrashort pulse laser diode. The monolithic mode-locked laser diode may be a monolithic semiconductor laser.

Monolithic mode-locked laser diodes usually have a longer pulse duration compared to a Ti: sapphire laser. The monolithic mode-locked laser diode may thus have a pulse duration of more than 2 ps [picoseconds]. This can extend the duration of the process. This is not due to the length of the pulses themselves, since a picosecond is a very short period of time. It is rather the case that with a longer pulse duration, the pulse peak intensity is lower and therefore the probability of two-photon absorption occurring is lower. A location must therefore be irradiated for longer until the starting material is polymerized there. This means that the material growth per pulse is lower, which enables a more precise control of the resolving power of individual structural properties of the object. Due to the fact that the process duration was expected to be longer, monolithic mode-locked laser diodes were considered to be unsuitable for two-photon polymerization in the past. Since the development of monolithic laser diodes around 30 years ago, they have not been used for two-photon polymerization even though this has also been established for more than 20 years. However, it has been found according to the invention that the smaller size of the monolithic mode-locked laser diode not only produces the immediately apparent advantages. In fact it has also been discovered that a monolithic mode-locked laser diode can be arranged in the write head. In known apparatuses for producing an object by way of two-photon polymerization, the laser source must be arranged outside the write head due to its size. The fact that this is possible with a monolithic mode-locked laser diode is attributable, in particular, to the dispensable means for pumping the laser.

By integrating the monolithic mode-locked laser diode in the write head, a substantial proportion of the optics of known apparatuses for producing an object by way of two-photon polymerization can also be dispensed with. An apparatus for producing an object by way of two-photon polymerization that corresponds approximately to a conventional paper printer in terms of size and mass can thus be obtained. For example, an apparatus of this kind may have a volume in the cubic centimeter range and a weight in the range of a few kilograms. The apparatus can therefore be designed to be portable. In comparison with known apparatuses, a considerable cost saving can be achieved. Furthermore, by integrating the monolithic mode-locked laser diode into the write head, it is not necessary to arrange the optics in a special enclosure according to the laser protection class. The write head described and a corresponding apparatus for producing an object by way of two-photon polymerization can therefore also be used outside a special laboratory and not only by specially trained personnel. It is therefore preferable for the write head to comprise a housing. The monolithic mode-locked laser diode is preferably arranged inside the housing. The microscope objective is preferably arranged at the edge of the housing such that the laser radiation can leave the housing via the microscope objective. The housing preferably has an extent of less than 50 cm, in particular less than 20 cm, in each spatial direction. In particular, this is how the write head differs from a complete conventional apparatus for producing an object by way of two-photon polymerization.

In addition, the efficiency of monolithic mode-locked laser diodes is also greater than in the case of lasers previously used for two-photon polymerization, in particular laser systems pumped multiple times. All of these previously unrecognized advantages of using monolithic mode-locked laser diodes compensate for the disadvantage of the longer process duration.

Preferably, the monolithic mode-locked laser diode has a pulse duration in the range from 2 ps to 10 ps [picoseconds]. On the one hand this is achieved with a comparatively simple design of the monolithic mode-locked laser diode. On the other hand, two-photon polymerization with an acceptable process duration is feasible with such a pulse duration.

Preferably, the write head comprises a heat sink in order to cool the monolithic mode-locked laser diode. Furthermore, the write head comprises a microscope objective. This is used to focus the laser radiation generated by the monolithic mode-locked laser diode in such a way that two-photon polymerization occurs at the desired locations in the starting material. It is preferable for the monolithic mode-locked laser diode to be arranged directly on the microscope objective. This means that the laser radiation generated by the monolithic mode-locked laser diode reaches the microscope objective without being influenced by another element in between. This is advantageous because every element in the beam path reduces the intensity of the laser radiation and can thus extend the process duration. Alternatively, however, it is possible to integrate different elements in the beam path. Several preferred embodiments which can be combined with one another as desired are described below.

In a preferred embodiment, the write head further comprises a camera and a beam splitter that is configured and arranged to allow the laser radiation emitted by the monolithic mode-locked laser diode to pass through and to deflect counter-propagating radiation to the camera.

The camera is used to control the production of the object by way of two-photon polymerization. In particular, the camera is used to determine the position and/or orientation of the starting material. This should be understood in such a way that the position of the object is also determined if said object has already been obtained from the starting material. This knowledge can be used as feedback for the positioning and/or orientation of the starting material. In this way, the positioning and/or orientation of the starting material can be carried out using information acquired with the aid of the camera. In particular, the holder can be adjusted based on information acquired by means of the camera.

The camera can be used to detect the starting material along the beam path also taken by the laser radiation, in any case between the beam splitter and the starting material. The camera therefore does not show the starting material in a perspectively distorted manner, but rather exactly in the manner relevant for orienting the laser radiation. This is possible due to the beam splitter. The beam splitter is integrated in the beam path of the laser radiation such that the laser radiation can pass through the beam splitter. This means that, apart from unavoidable losses, the laser radiation can pass through the beam splitter uninfluenced. By contrast, radiation originating from the starting material is deflected by the beam splitter, and therefore does not reach the monolithic mode-locked laser diode. This radiation is referred to as counter-propagating radiation in order to differentiate it from the laser radiation. The counter-propagating radiation is the radiation by means of which the starting material can be optically detected. The counter-propagating radiation is deflected by the beam splitter to the camera such that the camera can detect the counter-propagating radiation. The beam splitter is preferably designed such that the counter-propagating radiation, except for an unavoidable portion thereof, is deflected entirely to the camera. A dichroic beam splitter is preferred as the beam splitter. The beam splitter is preferably integrated in the beam path at an angle in the range from 30 to 60°, in particular 45°. Even with a compact design of the write head, it is thus easily possible to arrange the camera and the monolithic mode-locked laser diode in the write head. The camera is preferably a CCD camera.

The counter-propagating radiation preferably originates from a light source by means of which the starting material is illuminated. The light source may be part of the apparatus for producing an object by way of two-photon polymerization. The holder is preferably arranged between the light source and the write head. The light source is preferably an LED. The starting material can therefore be illuminated in such a way that it can be detected particularly well by the camera. In principle, however, it is also possible to use the camera in ambient light and without a special light source.

The design with a camera and beam splitter in the write head is facilitated by the particularly small size of the monolithic mode-locked laser diode. This advantage thus only results from the combination of a monolithic laser diode with the present embodiment. The camera and the beam splitter are preferably arranged inside the housing.

In another preferred embodiment, the write head further comprises a device for adjusting the orientation of the laser radiation emitted by the monolithic mode-locked laser diode.

The laser radiation can be controlled in two dimensions using the device for adjusting the orientation of the laser radiation emitted by the monolithic mode-locked laser diode. It is therefore sufficient to move the starting material and the write head relative to one another perpendicularly to these two dimensions, for example by means of the holder. This is a movement of the starting material toward or away from the write head. In comparison with a three-dimensional movement of the starting material, it is faster to adjust the orientation of the laser radiation. For this reason, the process duration in the present embodiment is particularly short.

It is also possible to move the starting material in these two dimensions, for example by means of the holder, in addition to the adjustment of the laser beam using the device for adjusting the orientation of the laser radiation emitted by the monolithic mode-locked laser diode. This is advantageous, in particular, in the case of relatively large objects to be produced.

The device for adjusting the orientation of the laser radiation emitted by the monolithic mode-locked laser diode is preferably a galvanometer scanner. Said scanner preferably comprises at least one galvanometer mirror, in particular exactly two galvanometer mirrors. A galvanometer mirror is a rapidly movable mirror by means of which the laser radiation can be deflected in a targeted manner. If the laser radiation is directed via the galvanometer mirror or mirrors, the orientation of the laser radiation can be adjusted by adjusting the galvanometer mirrors. This can be done very quickly.

The design with the device for adjusting the orientation of the laser radiation emitted by the monolithic mode-locked laser diode integrated in the write head is facilitated by the particularly small size of the monolithic mode-locked laser diode. This advantage thus only results from the combination of a monolithic laser diode with the present embodiment. The device for adjusting the orientation of the laser radiation emitted by the monolithic mode-locked laser diode is preferably arranged inside the housing.

In another preferred embodiment, the write head further comprises a device for adjusting the intensity of the laser radiation emitted by the monolithic mode-locked laser diode.

The intensity of the emitted laser radiation can be adjusted in order to achieve the most error-free structuring of the object to be produced. For example, fine structures of the object can thus be produced in a particularly careful and thus precise manner with a lower intensity and an accordingly slower process speed.

The device for adjusting the intensity of the laser radiation emitted by the monolithic mode-locked laser diode is preferably a neutral-density filter. Depending on the process speed, mechanically controlled neutral-density filters are conceivable for this purpose. The intensity of the laser radiation may also be adapted to the chemical composition of the starting material.

As an alternative or in addition to the embodiment described here, the intensity of the laser radiation may also be electronically adjusted directly by means of the monolithic mode-locked laser diode. This is not sufficiently fast and accurate with laser systems previously used for two-photon polymerization. For example, the intensity of the laser radiation emitted by the monolithic mode-locked laser diode can be set by means of a targeted change in the operating point of the monolithic mode-locked laser diode.

The design with the device for adjusting the intensity of the laser radiation emitted by the monolithic mode-locked laser diode integrated in the write head is facilitated by the particularly small size of the monolithic mode-locked laser diode. In other words this advantage only results from the combination of a monolithic laser diode with the present embodiment. The device for adjusting the intensity of the laser radiation emitted by the monolithic mode-locked laser diode is preferably arranged inside the housing.

As an alternative or in addition to the device for adjusting the intensity of the laser radiation emitted by the monolithic mode-locked laser diode, the write head preferably comprises a shutter. By means of said shutter, the laser radiation can be switched on and off.

In another preferred embodiment, the write head further comprises collimating optics between the monolithic mode-locked laser diode and the microscope objective.

The laser radiation emitted by the monolithic mode-locked laser diode is collimated, i.e. made parallel, by means of the collimating optics. This facilitates the targeted focusing with the microscope objective.

The design with the collimating optics integrated in the write head is facilitated by the particularly small size of the monolithic mode-locked laser diode. In other words this advantage only results from the combination of a monolithic laser diode with the present embodiment. The collimating optics are preferably arranged inside the housing.

Although the elements according to the above-described embodiments can all be used at the same time, it is preferable to integrate as few of these elements in the beam path as possible. As a result, the intensity of the laser radiation is reduced as little as possible and stability in relation to vibrations and shocks is increased. It is preferable for the write head to be modular in design in such a way that the elements according to the above-described embodiments can optionally be inserted as a respective module in the write head.

A module of this kind in each case comprises one of the following four elements or combination of elements:

the camera and the beam splitter,

the device for adjusting the orientation of the laser radiation emitted by the monolithic mode-locked laser diode,

the device for adjusting the intensity of the laser radiation emitted by the monolithic mode-locked laser diode,

the collimating optics.

Depending on the application, one or more of these modules can be inserted in the write head. This modular design is only possible by virtue of the small size of the monolithic mode-locked laser diode. The modules can, in particular, be inserted in the housing. The housing preferably comprises fastening means for one or more of these modules.

An apparatus for producing an object by way of two-photon polymerization is presented as a further aspect of the invention. The apparatus comprises:

a write head designed as described,

a holder for holding a photosensitive starting material, such that the object can be produced by way of two-photon polymerization from the photosensitive starting material using the write head.

The described advantages and design features of the write head can be applied and transferred to the apparatus, and vice versa. The write head is preferably intended and configured to be used in an apparatus designed as described. Preferably, the described apparatus comprises a control device which is intended and configured to carry out the described method.

In a preferred embodiment of the apparatus, the write head is arranged rigidly and the holder is configured to move the starting material.

The holder is preferably configured to move, in particular align and/or orient, the starting material in three dimensions. However, it is sufficient for the holder to be configured to move the starting material in one dimension, in particular when an apparatus for adjusting the orientation of the laser radiation emitted by the monolithic mode-locked laser diode is used. This is the direction toward or away from the write head. The holder may, in particular, be designed as a translational axis system having three degrees of freedom. The holder is preferably piezoelectrically controllable.

In another preferred embodiment, the apparatus further comprises a light source, wherein the holder is arranged between the light source and the write head. In this embodiment, in particular, it is preferable for the write head to further comprise a camera and a beam splitter, the beam splitter being configured and arranged to allow the laser radiation emitted by the monolithic mode-locked laser diode to pass through and to deflect counter-propagating radiation to the camera.

A method for producing an object by way of two-photon polymerization is presented as a further aspect of the invention. The method comprises:

a) providing a photosensitive starting material,

b) irradiating the starting material with laser radiation, such that the photosensitive starting material is polymerized locally by two-photon polymerization in such a way that the object is obtained from the starting material, the laser radiation being generated by means of a monolithic mode-locked laser diode.

The described special advantages and design features of the write head and apparatus can be applied and transferred to the method, and vice versa. The write head and the described apparatus are preferably intended and configured for operation according to the method. The method is preferably carried out using the described write head and, in particular, using the described apparatus.

A use of a monolithic mode-locked laser diode for two-photon polymerization is presented as a further aspect of the invention.

The described advantages and design features of the write head, apparatus, and method can be applied and transferred to the use, and vice versa.

As a preferred embodiment, a use of a monolithic mode-locked laser diode for producing an object by way of two-photon polymerization is presented.

The invention is explained in more detail below with reference to the drawings. The drawings show particularly preferred exemplary embodiments to which the invention is not limited, however. The drawings and the proportions shown therein are only schematic. In the drawings:

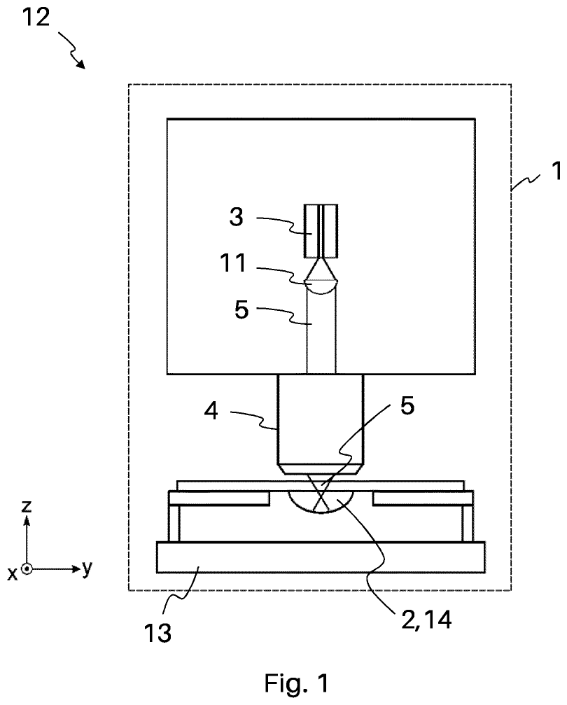

FIG. 1: shows a first embodiment of an apparatus according to the invention for producing an object by way of two-photon polymerization,

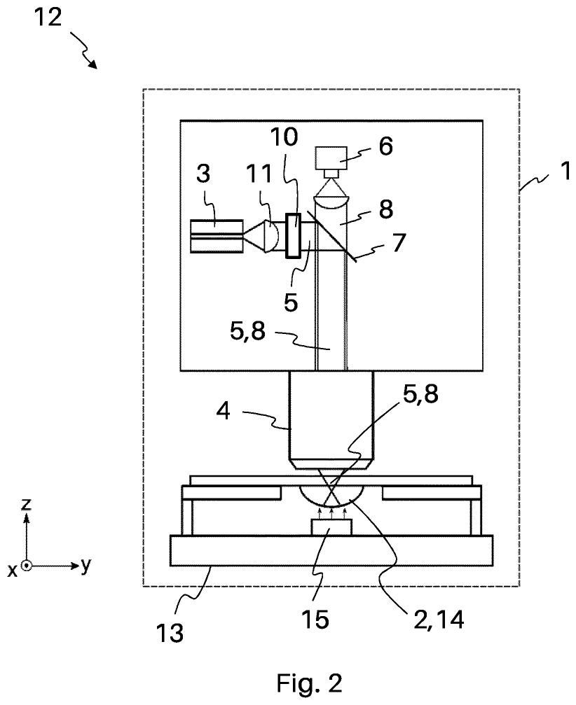

FIG. 2: shows a second embodiment of an apparatus according to the invention for producing an object by way of two-photon polymerization,

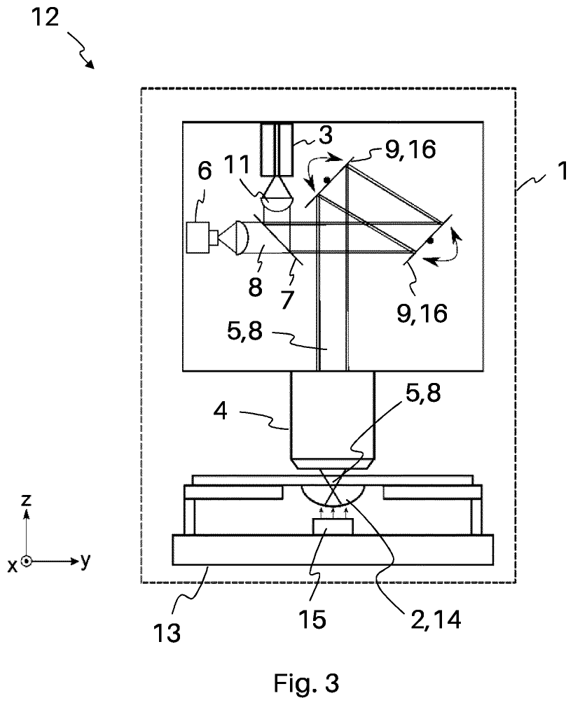

FIG. 3: shows a third embodiment of an apparatus according to the invention for producing an object by way of two-photon polymerization.

FIG. 1 shows a first embodiment of an apparatus 12 for producing an object 2 by way of two-photon polymerization. The object 2 is produced by irradiating a photosensitive starting material 14 with laser radiation 5. The starting material 14 is irradiated only where the object 2 to be obtained is to have material. In other words, the starting material 14 is polymerized locally by two-photon polymerization in such a way that the object 2 is obtained. The non-polymerized starting material 14 can subsequently be removed.

The apparatus 12 comprises a write head 1 and a holder 13 for holding the photosensitive starting material 14, such that the object 2 can be produced by way of two-photon polymerization from the photosensitive starting material 14 using the write head 1. Initially the holder 13 holds the starting material 14. Once the object 2 has been obtained from said starting material, the holder 13 will thus be holding the object 2. The write head 1 is arranged rigidly. The holder 13 can move the starting material 14 or the object 2 obtained therefrom in the three spatial directions x, y, and z. It is thus possible for the laser radiation 5 to be directed onto the locations in the starting material 14 that are to be polymerized. The laser radiation 5 can penetrate the starting material 14 and only polymerize the same where the laser radiation 5 is focused. This makes it possible for a three-dimensional object 2 to be obtained from the starting material 14.

The write head 1 comprises a monolithic mode-locked laser diode 3 and a microscope objective 4, which is configured and arranged to focus laser radiation 5 generated by the monolithic mode-locked laser diode 3. The laser radiation 5 emitted by the monolithic mode-locked laser diode 3 is used for the production of the object 2 by way of two-photon polymerization. The laser radiation 5 is focused by a microscope objective 4. Furthermore, the write head 1 comprises collimating optics 11 between the monolithic mode-locked laser diode 3 and the microscope objective 4.

FIG. 2 shows a second embodiment of an apparatus 12 for producing an object 2 by way of two-photon polymerization. Only the differences from the embodiment according to FIG. 1 are described. The write head 1 comprises a camera 6 and a beam splitter 7, which is configured and arranged to allow the laser radiation 5 emitted by the monolithic mode-locked laser diode 3 to pass through and to deflect counter-propagating radiation 8 to the camera 6. The counter-propagating radiation 8 is generated by a light source 15 of the apparatus 12. The holder 13 is arranged between the light source 15 and the write head 1. The counter-propagating radiation 8 generated by the light source 15 enters the write head 1 and then enters the camera 6 via the beam splitter 7. The camera 6 can thus detect the position of the starting material 14 or of the object 2 obtained therefrom along the beam path of the laser radiation 5. The holder 13 can thus be controlled particularly precisely. Furthermore, the apparatus 12 comprises a device 10 for adjusting the intensity of the laser radiation 5 emitted by the monolithic mode-locked laser diode 3.

FIG. 3 shows a third embodiment of an apparatus 12 for producing an object 2 by way of two-photon polymerization. Only the differences from the embodiments according to FIGS. 1 and 2 are described. The write head 1 thus comprises a device 9 for adjusting the orientation of the laser radiation 5 emitted by the monolithic mode-locked laser diode 3. This apparatus 9 is designed as a galvanometer scanner having two galvanometer mirrors 16. The laser radiation 5 can be deflected in a controllable manner in the x and y directions by means of the galvanometer mirrors 16. It therefore suffices to move the starting material 14 or the object 2 obtained therefrom in the z direction by means of the holder 13.

The features of the three embodiments according to FIGS. 1 to 3 can be combined with one another as desired. Each of the three embodiments may thus be designed with and without the device 9, with and without the device 10, and with and without the camera 6 and the beam splitter 7.

### LIST OF REFERENCE SIGNS

1 Write head
2 Object
3 Monolithic mode-locked laser diode
4 Microscope objective
5 Laser radiation
6 Camera
7 Beam splitter
8 Counter-propagating radiation
9 Device
10 Device
11 Collimating optics
12 Apparatus
13 Holder
14 Starting material
15 Light source
16 Galvanometer mirror

1. Write head for producing an object by way of two-photon polymerization, comprising:
a monolithic mode-locked laser diode,
a microscope objective that is configured and arranged to focus laser radiation generated by the monolithic mode-locked laser diode.

2. Write head according to claim 1, further comprising a camera and a beam splitter that is configured and arranged to allow the laser radiation emitted by the monolithic mode-locked laser diode to pass through and to deflect counter-propagating radiation to the camera.

3. Write head according to claim 1, further comprising a device for adjusting the orientation of the laser radiation emitted by the monolithic mode-locked laser diode.

4. Write head according to claim 1, further comprising a device for adjusting the intensity of the laser radiation emitted by the monolithic mode-locked laser diode.

5. Write head according to claim 1, further comprising collimating optics between the monolithic mode-locked laser diode and the microscope objective.

6. Apparatus for producing an object by way of two-photon polymerization, comprising:
a write head according to any one of the preceding claims,
a holder for holding a photosensitive starting material, such that the object can be produced by way of two-photon polymerization from the photosensitive starting material using the write head.

7. Apparatus according to claim 6, wherein the write head is arranged rigidly and the holder is configured to move the starting material.

8. Apparatus according to claim 6, further comprising a light source, wherein the holder is arranged between the light source and the write head.

9. Method for producing an object by way of two-photon polymerization, comprising:
a) providing a photosensitive starting material,
b) irradiating the starting material with laser radiation, such that the photosensitive starting material is polymerized locally by two-photon polymerization in such a way that the object is obtained from the starting material, wherein the laser radiation is generated by means of a monolithic mode-locked laser diode.

10. Use of a monolithic mode-locked laser diode for two-photon polymerization.

11. Write head according to claim 2, further comprising a device for adjusting the orientation of the laser radiation emitted by the monolithic mode-locked laser diode.

12. Write head according to claim 2, further comprising a device for adjusting the intensity of the laser radiation emitted by the monolithic mode-locked laser diode.

13. Write head according to claim 2, further comprising collimating optics between the monolithic mode-locked laser diode and the microscope objective.

14. Write head according to claim 3, further comprising a device for adjusting the intensity of the laser radiation emitted by the monolithic mode-locked laser diode.

15. Write head according to claim 3, further comprising collimating optics between the monolithic mode-locked laser diode and the microscope objective.

16. Write head according to claim 4, further comprising collimating optics between the monolithic mode-locked laser diode and the microscope objective.
